(19) United States
(12) Patent Application Publication
(10) Pub. No.: US 2009/0187957 A1
(43) Pub. Date: Jul. 23, 2009

(54) Delivery of Media Assets Having a Multi-Part Media File Format to Media Presentation Devices

(76) Inventor: Gokhan Avkarogullari, San Jose, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 12/037,831

(22) Filed: Feb. 26, 2008

Related U.S. Application Data
(60) Provisional application No. 61/021,811, filed on Jan. 17, 2008.

(51) Int. Cl. H04N 7/173

(52) U.S. Cl. 725/109

(57) ABSTRACT

Improved techniques and systems for electronic delivery of digital media asset files to electronic devices are disclosed. In one embodiment, a media item can be stored in a multi-part media item file. The multi-part media item file for the media item can be delivered to a host device that can thereafter support a plurality of different media presentation devices that have different media presentation capabilities. The host device can distribute customized (or optimized) versions of the multi-part media item file to different media presentation devices. In one embodiment, the multi-part media item file can include at least a plurality of video streams. When the media item is to be presented by one of the media presentation devices, the media presentation device can decode the plurality of video streams from the multi-part media item file into decoded video frames and then combine the decoded video frames from the different streams for presentation of video of the media item.

### CROSS-REFERENCE TO RELATED APPLICATION

This application claims priority to U.S. Provisional Patent Application No. 61/021,811, filed Jan. 17, 2008, entitled “DELIVERY OF MEDIA ASSETS HAVING A MULTI-PART MEDIA FILE FORMAT TO MEDIA PRESENTATION DEVICES”, which is herein incorporated by reference.

### BACKGROUND OF THE INVENTION

1. Field of the Invention

The present invention relates to media distribution and, more particularly, to media distribution to media presentation devices.

2. Description of the Related Art

Today, online media stores, such as iTunes™ Music Store provided by Apple Inc., provide users with access to many digital media assets (i.e., media items such as songs, videos, etc.). Users having computing devices with Internet access can browse, review and purchase media items available from an online media store. When a media item is purchased from an online media store, an electronic media file containing media data for the media item is delivered to the purchaser via the Internet. Typically, the media data contained in the electronic media file has a compressed file format, such as MP3, AAC or MPEG (e.g., MPEG4) for audio and Quicktime or MOV for video.

Unfortunately, however, it is common today for a user to utilize more than one media playback device to play the music or videos. For example, a single user might utilize a mobile phone, a portable media player and a set top box to provide media playback. As a result, it is difficult to provide a purchaser with an electronic media file that is suitable for their various media playback devices. For example, a given user might purchase a digital media item (e.g., music or movie) online and have the corresponding electronic media file delivered via the Internet. However, such electronic media file might not be suitable for use on one or more of the media playback devices of the purchaser. While the purchaser could purchase another version of the digital media item that is suitable for the other media playback devices, such would not only requires another payment for the same digital media asset but also would complicate storage and management because two or more different electronic files would need to be maintained for the same digital media asset. Since the electronic video files tend to be large files (unless the video is very short in duration), there is a need for improved approaches to deliver and manage media files for multiple media playback devices.

### SUMMARY OF THE INVENTION

The invention pertains to techniques and systems for electronic delivery of digital media asset files to electronic devices. In one embodiment, a media item can be stored in a multi-part media item file. The multi-part media item file for the media item can be delivered to a host device that can thereafter support a plurality of different media presentation devices that have different media presentation capabilities. The host device can distribute customized (or optimized) versions of the multi-part media item file to different media presentation devices. In one embodiment, the multi-part media item file can include at least a plurality of video streams. When the media item is to be presented by one of the media presentation devices, the media presentation device can decode the plurality of video streams from the multi-part media item file into decoded video frames and then combine the decoded video frames from the different streams for presentation of video of the media item.

The invention can be implemented in numerous ways, including as a method, system, device, or apparatus (including computer readable medium). Several embodiments of the invention are discussed below.

As a method for processing a digital media asset for presentation, one embodiment of the invention can, for example, include at least: identifying a digital media asset having high quality video; processing the high quality video to produce multiple reduced quality streams that are complementary; distributing the multiple reduced quality video streams to a host device; determining, at the host device, which of the multiple reduced quality video streams are to be downloaded to a particular media playback device; downloading the determined video streams to the media playback device; and presenting video for the digital media asset at the particular media playback device using the determined video streams that have been downloaded to the particular media playback device.

As a method of distributing media item data to a media playback device, one embodiment of the invention can, for example, include at least: determining capabilities of the media playback device; determining a set of parts of a media item having a multi-part format based on the capabilities of the media playback device; and electronically delivering the determined set of parts of the media item to the media playback device.

As a method for presenting a media item on a media presentation device, one embodiment of the invention can, for example, include at least: identifying a multi-part media item file for the media item to be presented on the media presentation device; retrieving a frame from a first stream provided in a first part of the multi-part media item file; decoding the retrieved frame from the first stream; retrieving a frame from a second stream provided in a second part of the multi-part media item file; decoding the retrieved frame from the second stream; and combining the decoded frame from the first stream with the decoded frame from the second stream to produce a resulting frame.

As a computer readable medium including at least executable computer program code tangibly stored thereon for distributing media item data to a media playback device, one embodiment of the invention can, for example, include at least: computer program code for determining capabilities of the media playback device; computer program code for determining a set of parts of a media item having a multi-part format based on the capabilities of the media playback device; and computer program code for delivering the determined set of parts of the media item to the media playback device.

As a computer readable medium including at least executable computer program code tangibly stored thereon for presenting a media item on a media presentation device, one embodiment of the invention can, for example, include at least: computer program code for identifying a multi-part media item file for the media item to be presented on the media presentation device; computer program code for retrieving a frame from a first stream provided in a first part of the multi-part media item file; computer program code for decoding the retrieved frame from the first stream; computer program code for retrieving a frame from a second stream provided in a second part of the multi-part media item file; computer program code for decoding the retrieved frame from the second stream; and computer program code for combining the decoded frame from the first stream with the decoded frame from the second stream to produce a resulting frame.

As a media asset distribution and presentation system, one embodiment of the invention can, for example, include at least: an online media repository configured to store a plurality of digital media assets, each of the plurality of the digital media assets including multiple reduced quality streams that are complementary; at least one media playback device having video playback capabilities; and a host computer configured to operatively connect to the online media repository and the media playback device. The host computer can be further configured to (i) determine which of the multiple reduced quality video streams for a particular digital media asset are to be downloaded to the media playback device, and (ii) download the determined video streams to the media playback device. The media playback device can thereafter present video for the particular digital media asset by combining the determined video streams that have been downloaded to the media playback device.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a media distribution system according to one embodiment of the invention.

FIG. 2 is a flow diagram of a video management process according to one embodiment of the invention.

FIG. 3 is a media processing arrangement according to one embodiment of the invention.

FIG. 4 is a schematic diagram of a multi-part video process according to one embodiment of the invention.

FIG. 5A is a diagram of a multi-part media item file according to one embodiment of the invention.

FIG. 5B is a diagram of a media item file having only a single video track.

FIG. 5C is a diagram of a multi-part media item file according to another embodiment of the invention.

FIG. 6 is a flow diagram of a media item distribution process according to one embodiment of the invention.

FIGS. 7A and 7B are flow diagrams of a media item presentation process according to one embodiment of the invention.

FIGS. 8A and 8B are flow diagrams of a media item presentation process according to another embodiment of the invention.

FIG. 9 is a block diagram of a mobile multi-function device according to one embodiment of the invention.

### DETAILED DESCRIPTION OF THE INVENTION

The invention pertains to techniques and systems for electronic delivery of digital media asset files to electronic devices. In one embodiment, a media item can be stored in a multi-part media item file. The multi-part media item file for the media item can be delivered to a host device that can thereafter support a plurality of different media presentation devices that have different media presentation capabilities. The host device can distribute customized (or optimized) versions of the multi-part media item file to different media presentation devices. In one embodiment, the multi-part media item file can include at least a plurality of video streams. When the media item is to be presented by one of the media presentation devices, the media presentation device can decode the plurality of video streams from the multi-part media item file into decoded video frames and then combine the decoded video frames from the different streams for presentation of video of the media item.

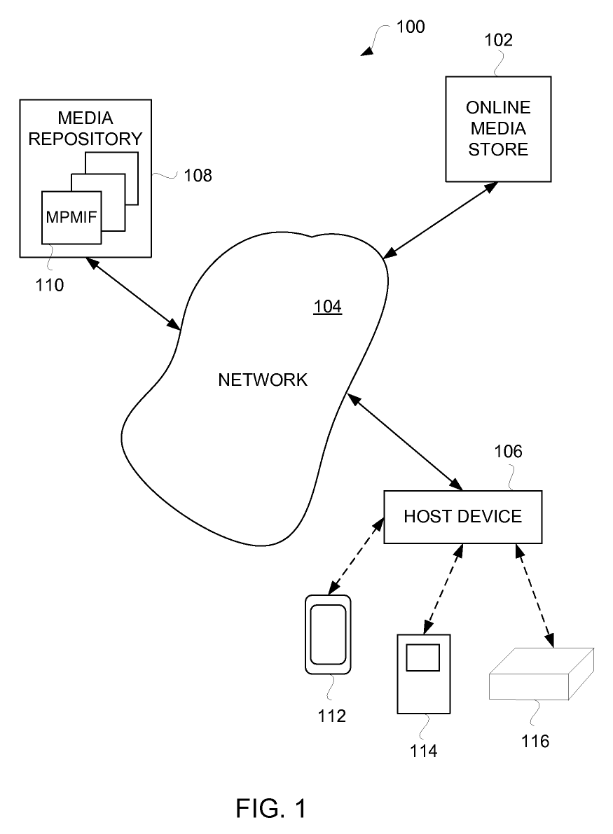

Embodiments of the invention are discussed below with reference to FIGS. 1-9. However, those skilled in the art will readily appreciate that the detailed description given herein with respect to these figures is for explanatory purposes as the invention extends beyond these limited embodiments.

FIG. 1 is a block diagram of a media distribution system 100 according to one embodiment of the invention. The media distribution system 100 includes an online media store 102. The online media store 102 provides an e-commerce media site that allows visitors to browse, search, preview, rent or purchase a wide variety of media items. The online media store 102 can couple to a network 104. The network 104 is typically a data network, such as a global public network (e.g., the World Wide Web or the Internet). However, in other implementations, the network 104 can pertain to a local area network or a wide area network.

The media distribution system 100 can support a plurality of host devices. For example, as illustrated in FIG. 1, the media distribution system 100 includes a host device 106. The host device 106, is, for example, a computing device, such as a personal computer, that can couple to the network 104 in a wired or wireless manner. A user of the host device 106 can visit the online media store 102 by way of the network 104. While at the online media store 102, visitors can browse, search, preview, rent or purchase a wide variety of media items. The host device 106 can also store media items that have been acquired (e.g., from the online media store 102 or otherwise) and manage such media items for one or more media presentation devices (media playback devices). As illustrated in FIG. 1, the host device 106 can support one or more media presentation devices. For example, the host device 106 can support different types of media presentation devices that have different capabilities given their hardware, software or configuration differences. FIG. 1 illustrates several representative media presentation devices, including a moderate resolution media playback device 112, a low resolution media playback device 114 and a high-resolution media playback device 116.

As illustrated in FIG. 1, any these media presentation devices 112, 114 or 116 can couple to the online media store 102 via the network 104 by coupling to the host device 106. In one embodiment, the host device 106 can manage the media items for the one or more media presentation devices 112, 114 or 116. Alternatively, any of the representative media presentation devices 112, 114 or 116 can alternatively connect to the online media store 102 more directly (i.e., without connecting to the host device 106) by connecting to the network 104 in a wired or wireless manner.

When a user of the host device 106 visits the online media store 102 to browse or search and then purchase a media item, the online media store 102 can process a purchase (or rental) for the media item. Then, the associated electronic file for the purchased media item can be downloaded from a media repository 108 to the host computer 106 via the network 104. For example, the media repository can store a plurality of media items that are available on the online media store 102. In one embodiment, one or more of the media items can be stored in the media repository 108 using a multi-part media item file 110. In such case, the multi-part media item file 110 can be downloaded to the host device 106 via the network 104. Thereafter, at the host device 106, the multi-part media item file 110 can be stored and utilized for presentation (e.g., playback) of the associated media item at the host device 106. Additionally, if the host device 106 is also configured to manage media items for one or more of the media presentation devices 112, 114 or 116, the host device 106 can also download the multi-part media item file (MPMIF) 110 to one or more of the media presentation devices 112, 114 or 116. However, as discussed in more detail below, given the media playback capabilities at the particular media presentation devices 112, 114 and 116, the host device 106 may download only a subset of the multi-part media item file 110 to a particular media presentation device. Advantageously, a particular media presentation device only receives that portion of the multi-part media item file 110 that is suitable for use on that particular media presentation device. For example, the moderate resolution media presentation device 112 may only receive two parts of the multi-part media item file 110, the low resolution media presentation device 114 may only receive one part of the multi-part media item file 110, and the high resolution media presentation device 116 may receive three parts of the multi-part media item file 110.

Additionally, in one embodiment, it should be noted that media (e.g., video) can be downloaded in parts, i.e., parts of a multi-part media items file. One part could be initially downloaded to the host device 106 with one or more subsequent parts be later downloaded to the host device 106. This type of download can be useful to initially acquire a low quality media version that is later upgraded automatically to a high quality version once the other parts of the multi-part media item are downloaded.

Also, in one embodiment, when viewing media (e.g., video), user action may request fast forwarding or rewinding. In such case, the media could present only the video content for a first part while fast forwarding or rewinding so as to reduce latency due to processing that would be imposed if video content from all appropriate parts were to be used.

Digital Rights Management (DRM) approaches can be used to further cryptographically secure some or all parts of a multi-part media items file to limit copying and usage of the associated media item. For example, it may be adequate for only one part (e.g., video part) of the multi-part media items file to be secured. As another example, it may be adequate to secure only portions of one or more of the parts of the multi-part media item file.

In still another embodiment, instead of a file download, a media item at the media repository 108 can have its data streamed to the host device 106 (or directly to a presentation devices). Since the host device 106 can represent the different media presentation devices 112, 114 or 116, the streaming can be dependent on the media playback capabilities of the intended destination device. In one implementation, the streaming of the multi-part media item file can be performed such that the part of the multi-part media item file can be streamed in an interleaved fashion, wherein corresponding frames from each sub-part can be subsequently transmitted. A recipient device that is to present the media item being streams can combine the multiple sub-part streams and present the resulting media item at the destination device. In the case where the streaming is over a wireless network, the streaming can be more bandwidth efficient because the streaming is performed in accordance with the media playback capabilities of the destination device, such that the sub-streams not usable need not be transmitted. Streaming offers the advantage of presentation of the media item soon after streaming begins without have to await download of an entire media item file.

Thereafter, at the host device 106, the multi-part media item file 110 can be stored and utilized for presentation (e.g., playback) of the associated media item at the host device 106.

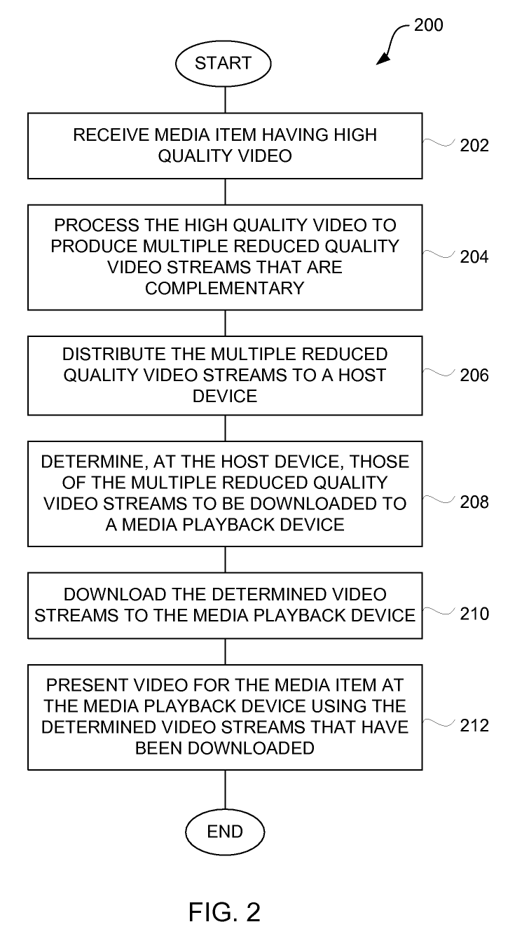

FIG. 2 is a flow diagram of a video management process 200 according to one embodiment of the invention. The video management process 200 is, for example, performed by a media distribution system, such as the media distributed system 100 illustrated in FIG. 1. Although the video management process 200 can be performed by a single computing device, in one embodiment, the video management process 200 can be performed in full or in part by several different computing devices (e.g., a server computer, a host device and/or a media presentation device).

The video management process 200 initially receives 202 a media item having high-quality video. The high-quality video can then be processed 204 to produce multiple reduced quality video streams that are complementary. For example, one of the video streams can be a baseline stream, while other of the streams can be residual streams that can be used to enhance video resulting from the baseline stream. Next, the multiple reduced quality video streams can be distributed 206 to a host device. At the host device, those of the multiple reduced quality video streams to be downloaded to a media playback device can be determined 208. Thereafter, the determined video streams can be downloaded 210 to the media playback device. After being downloaded to the media playback device, video for the media item can be presented 212 at the media playback device using the determined video streams that have been successfully downloaded to the media playback device. Following the block 212, the video management process 210 can end.

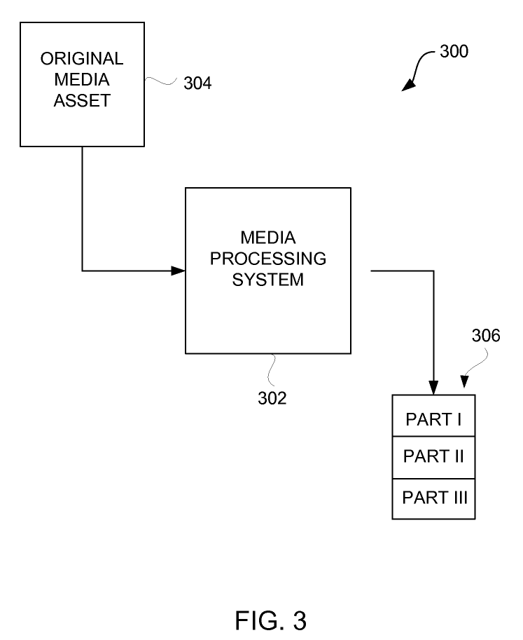

FIG. 3 is a media processing arrangement 300 according to one embodiment of the invention. The media processing arrangement 300 includes a media processing system 302 that can process digital media assets into a multi-part format. The media processing system receives an original media asset 304 that is to be processed by the media processing arrangement 300. The original media asset 304 is, for example, a video item (e.g., movie) or an audio item (e.g., song). The media processing system 302 receives the original media asset 304 and performs processing to output a multi-part media asset 306. In one embodiment, the multi-part media asset is a multi-part media item file that includes multiple parts. As illustrated in FIG. 3, the multi-part media item file can include a plurality of parts, namely, part I, part II and part III. More generally, it should be understood that the multi-part media item file can include two or more such parts. Each of the parts can contain media data that can be presented on a media presentation device (e.g., personal computer, media playback device, etc.). The more of the parts being used the better the resolution of the media being presented.

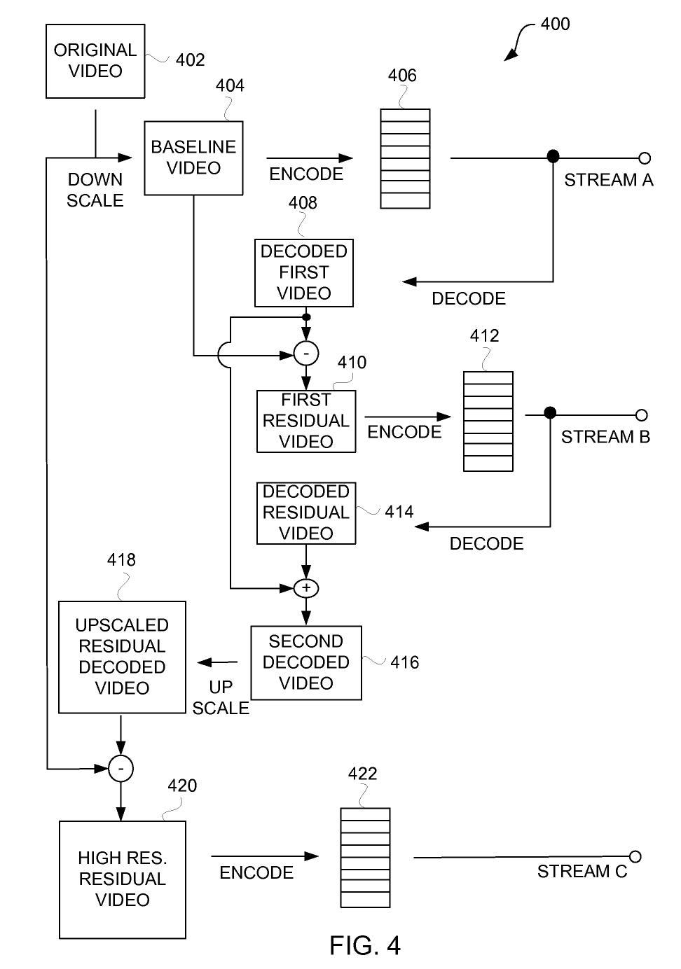

FIG. 4 is a schematic diagram of a multi-part video process 400 according to one embodiment of the invention. The multi-part video process 400 is, for example, processing performed by the media processing system 302 illustrated in FIG. 3.

The multi-part video process 400 initially receives an original video 402. The original video 402 is, in this example, assumed to be 1280×720 resolution (e.g., at thirty (30) or sixty (60) frames per second). The original video 402 is downscaled to a baseline video 404. The baseline video is assumed to be 640×480 resolution. Here, the downscaling can be implemented by sub-sampling filter. The baseline video 404 can be encoded into a video stream A 406. For example, the encoding of the video stream A 406 can use H.264, e.g., H.264 baseline profile VGA low complexity. In one implementation, the video stream A 406 is a compressed video stream with a rate of about 1-3 megabytes/second (MB/s) for typical video sources. The video stream A 406 can also be decoded into first decoded video 408, which is viewable video. The first decoded video 408 in this embodiment can also be 640×480 resolution. The baseline video 404 can then be combined with the decoded video 408 to produce a first residual video 410. In particular, the first decoded video 408 can be subtracted from the baseline video 404 to produce the first residual video 410. The first residual video 410 can be encoded to produce a video stream B 412. For example, the encoding of the video stream B 412 can use H.264, e.g., H.264 baseline profile. In one implementation, the video stream B 412 is a compressed video stream with a rate of about 1-10 megabytes/second (MB/s) for typical video sources. The video stream B 412 can also be decoded to yield decoded residual video 414. The decoded residual video 414 in this embodiment can also be 640×480 resolution. The decoded residual video 414 can be combined with the first decoded video 408 to produce a second decoded video 416. In one example, the decoded residual video 414 is added to the decoded first video 408 to produce the second decoded video 416, which is viewable video. The second decoded video 416 in this embodiment can also have 640×480 resolution.

Still further, the second decoded video 416 can be upscaled to obtain upscaled second decoded video 418. The upscaled second decoded video 418 is assumed to be 1280×720 resolution. The upscaled second decoded video 418 can be combined with the original video 402 to yield high resolution residual video 420. In particular, in one example, the upscaled second decoded video 418 can be subtracted from the original video 402 to produce the high resolution residual video 420. Subsequently, the high resolution residual video 420 can be encoded to produce a video stream C 422. For example, the encoding of the video stream C 422 can use H.264, e.g., H.264 high profile. In one implementation, the video stream C 422 is a compressed video stream with a rate of about 1-10 megabytes/second (MB/s) for typical video sources.

The video streams A, B and C produced by the multi-part video process 400 can be stored together in a multi-part media item file. In one implementation, the video streams A, B and C produced by the multi-part video process 400 can be individually associated with different parts of a multi-part media item file, such as the multi-part media item file 306 illustrated in FIG. 3. When the media item corresponding to the media item data stored in a multi-part media item file is to be presented, a media presentation device can make use of one or more of the video streams A, B or C. In one example, the media presentation device might present the media item using the video stream A supplemented by the video stream B. In another example, the media presentation device might present the media item using the video stream A supplemented by the video stream B and the video stream C.

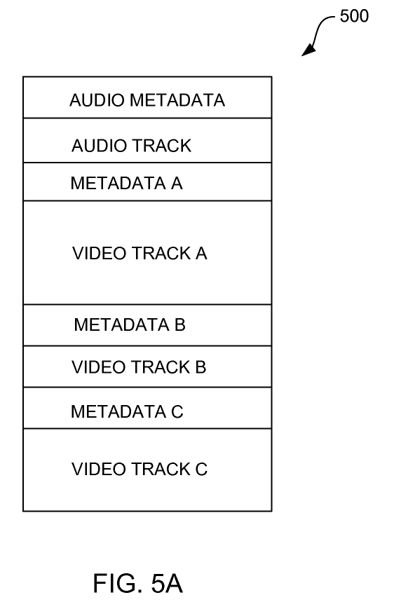

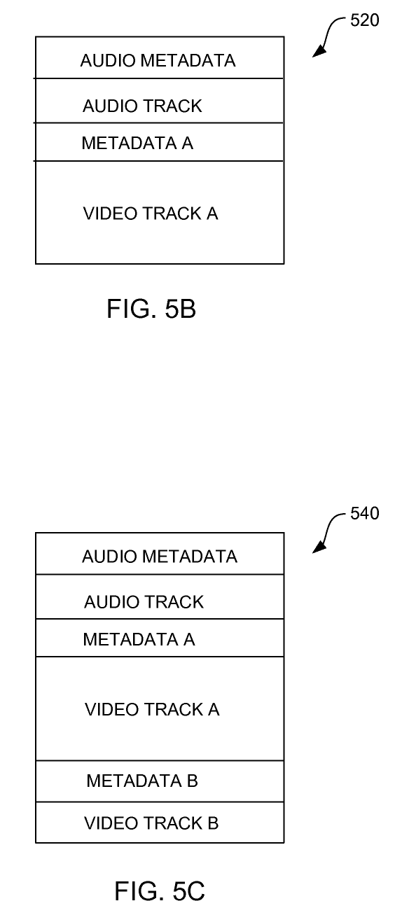

FIG. 5A is a diagram of a multi-part media item file 500 according to one embodiment of the invention. The multi-part media item file 500 includes a plurality of different parts. However, with respect to video components, the multi-part media item file includes three video parts, namely, video track A, video track B and video track C. In one implementation, the video track A can correspond to the video stream A 406 illustrated in FIG. 4, the video track B can correspond to the video stream B 412 illustrated in FIG. 4, and the video track C can correspond to the video stream C 422 illustrated in FIG. 4. However, as illustrated in FIG. 5A, the multi-part media item file 500 can include other parts beyond those parts containing video data. As illustrated in FIG. 5A, the multi-part media item file 500 can also include metadata for one or more of the video tracks A, B and C. Still further, the multi-part media item file 500 can include audio data, namely at least one audio track and audio metadata corresponding to the at least one audio track. Although not illustrated in FIG. 5A, the multi-part media item file 500 could also include audio tracks in a multi-part format such as is provided for the video data.

FIG. 5B is a diagram of a media item file 520 having only a single video track, namely, video track A. In the media item file 520 also includes metadata for the video track A as well as an audio track and audio metadata for the audio track. Although the media item file 520 includes an audio track and the video track (as well as metadata), and the media item file 520 is not considered a multi-part media item file because it does not include multiple complementary audio tracks or multiple complementary video tracks. However, the media item file 520 is a subset of the multi-part media item file.

FIG. 5C is a diagram of a multi-part media item file 540 according to another embodiment of the invention. The multi-part media item file 540 includes a plurality of different parts. With respect to video components, the multi-part media item file includes two video parts, namely, video track A and video track B. In one implementation, the video track A can correspond to the video stream A 406 illustrated in FIG. 4, and the video track B can correspond to the video stream B 412 illustrated in FIG. 4. However, as illustrated in FIG. 5C, the multi-part media item file 540 can include other parts beyond those parts containing video data. As illustrated in FIG. 5C, the multi-part media item file 540 can also include metadata for one or more of the video tracks A and B. Still further, the multi-part media item file 540 can include audio data, namely at least one audio track and audio metadata corresponding to the at least one audio track. Although not illustrated in FIG. 5C, the multi-part media item file 500 could also include audio tracks in a multi-part format such as is provided for the video data.

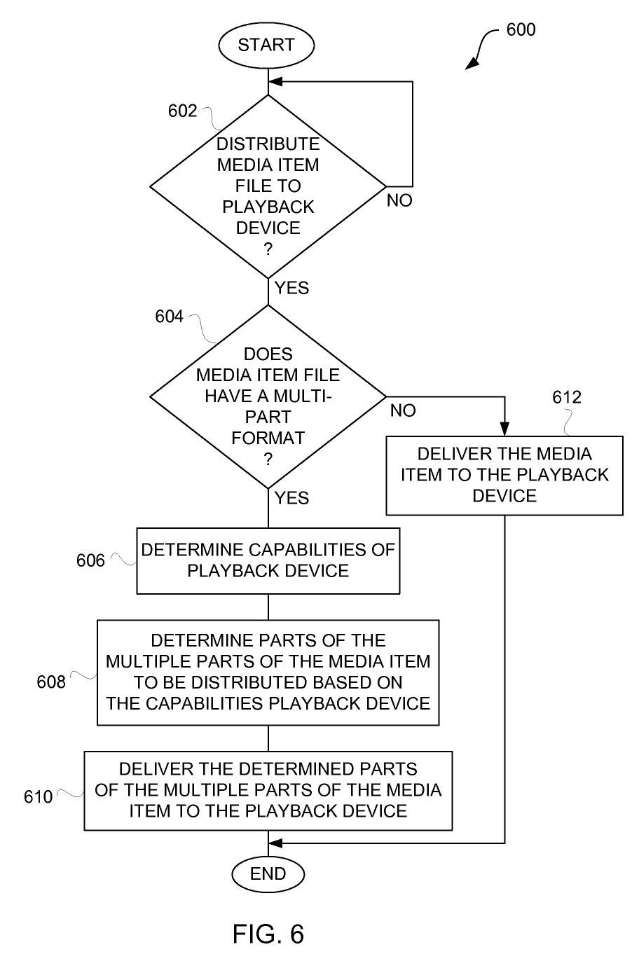

FIG. 6 is a flow diagram of a media item distribution process 600 according to one embodiment of the invention. The media item distribution process 600 can be performed by a host device, such as the host device 106 illustrated in FIG. 1. Alternatively, the media item distribution process 600 can be performed by a media repository, such as the media repository 108 illustrated in FIG. 1.

The media item distribution process 600 can begin with a decision 602 that determines whether a media item is to be distributed to a playback device (media playback device). When the decision 602 determines that a media item is not to be distributed to a playback device at this time, the media item distribution process 600 can wait until distribution is needed. In other words, the media item distribution process 600 can be invoked when a media item file is to be distributed to a playback device.

In any case, when the decision 602 determines that a media item file is to be distributed to a playback device, a decision 604 can determine whether the media item file has a multi-part format. When the decision 604 determines that the media item file has a multi-part format, processing can be performed to deliver appropriate parts of the multi-part media item to be playback device. In particular, capabilities of the playback device are determined 606. For example, a DVD playback device can include or associate with a display that supports a high resolution. The capabilities of the playback device can thus inform the host device of what format the media item being distributed to the playback device should take. Hence, the media item distribution process 600 can determine 608 those parts of the multiple parts of the media item to the distributed based on the capabilities of the playback device. Thereafter, the determined parts of the multi-parts of the media item can be delivered 610 to the playback device.

On the other hand, when the decision 604 determines that the media item file does not have a multi-part format, the media item can be delivered 612 to the playback device in its entirety. Hence, when the decision 604 determines that the media item file does not have a multi-part format, the media item file having a conventional format can be delivered 612. Following the blocks 610 and 612, the media type distribution process 600 can end.

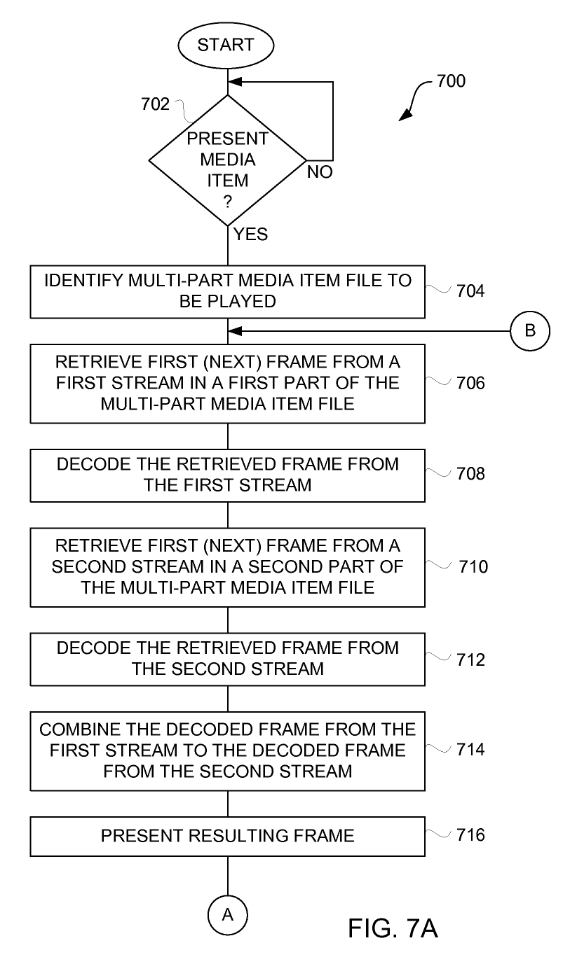

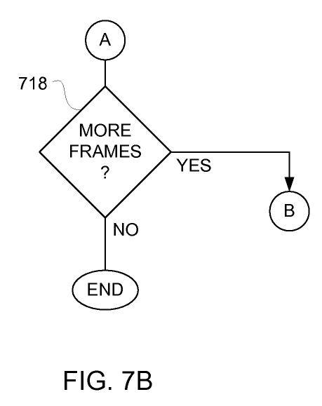

FIGS. 7A and 7B are flow diagrams of a media item presentation process 700 according to one embodiment of the invention. The media item presentation process 700 is, for example, performed by a media presentation device, such as a media playback device.

The media item presentation process 700 can begin with a decision 702 that determines whether a media item is to be presented. When the decision 702 determines that a media item is not be presented at this time, the media item presentation process 700 can await an appropriate time to present a media item. In other words, the media item presentation process 700 can be deemed invoked when a media item is to be presented.

In any case, when the decision 702 determines that a media item is to be presented, a multi-part media item file to be played can be identified 704. Here, it is assumed that the media item to be presented is available to (e.g., stored on) the media presentation device and has a multi-part media item file as discussed herein. Given that the media item to be presented has a multi-part media item file, the presentation of the multi-part media item file requires additional processing.

Initially, a first frame from a first stream in the first part of the multi-part media item file can be retrieved 706. The retrieved frame from the first stream can then be decoded 708. In addition, a first frame from a second stream in the second part of the multi-part media item file can be retrieved 710. The retrieved frame from the second stream can then be decoded 712. The decoded frame from the first stream can then be combined 714 to the decoded frame from the second stream to produce a resulting frame. In one implementation, the decoded frames being combined 714 can add the decoded frame from the first stream to the decoded frame from the second stream, where the addition can sum pixel values on a pixel by pixel basis. The resulting frame can then be presented 716. For example, the presenting 716 of the resulting frame can cause the resulting frame to be displayed on a display on the media presentation device.

Following the presentation 716 of the resulting frame, a decision 718 can determine whether more frames of the multi-part media item file (i.e., more frames within the first stream and the second stream) are to be similarly processed. When the decision 718 determines that there are more frames to be similarly processed, the media item presentation process 700 returns to repeat the block 706 so that a next frame from the first stream and a next frame for the second stream can be retrieved, decoded and then combined. However, when the decision 718 determines that there are no more additional frames to be processed, the media item presentation process 700 can end.

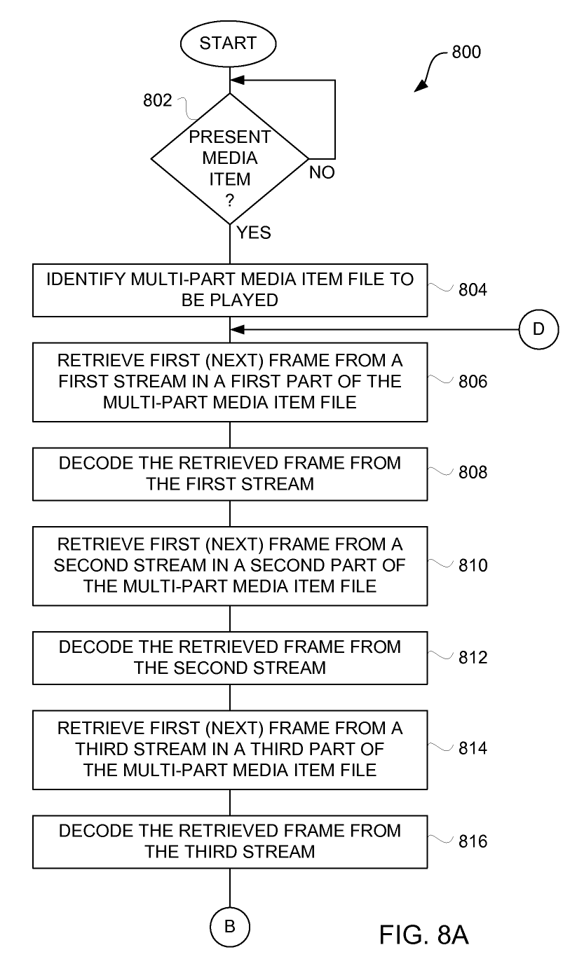

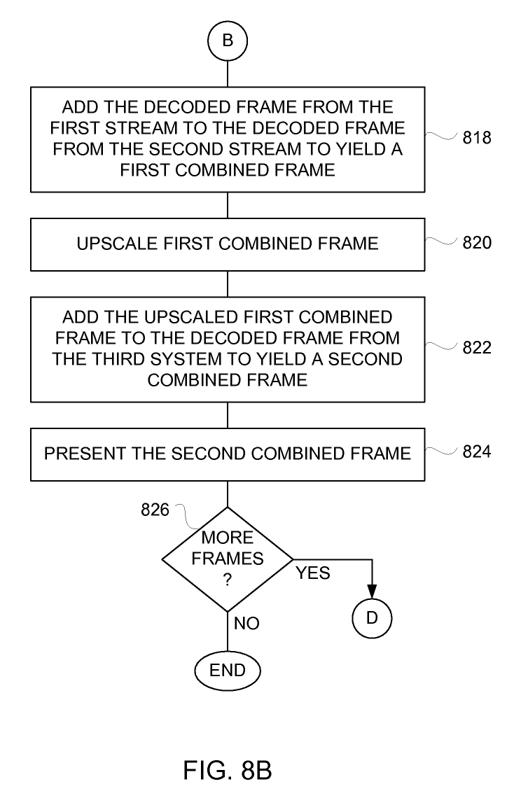

FIGS. 8A and 8B are flow diagrams of a media item presentation process 800 according to another embodiment of the invention. The media item presentation process 800 is, for example, performed by a media presentation device, such as a media playback device.

The media item presentation process 800 can begin with a decision 802 that determines whether a media item is to be presented. When the decision 802 determines that a media item is not be presented at this time, the media item presentation process 800 can await an appropriate time to present a media item. In other words, the media item presentation process 800 can be deemed invoked when a media item is to be presented.

In any case, when the decision 802 determines that a media item is to be presented, a multi-part media item file to be played can be identified 804. Here, it is assumed that the media item to be presented is available to (e.g., stored on) the media presentation device and has a multi-part media item file as discussed herein. Given that the media item to be presented has a multi-part media item file, the presentation of the multi-part media item file requires additional processing.

Initially, a first frame from a first stream in the first part of the multi-part media item file can be retrieved 806. The retrieved frame from the first stream can then be decoded 808. In addition, a first frame from a second stream in the second part of the multi-part media item file can be retrieved 810. The retrieved frame from the second stream can then be decoded 812. Further, a first frame from a third stream in the third part of the multi-part media item file can be retrieved 814. The retrieved frame from the third stream can then be decoded 816.

The decoded frame from the first stream can then be added 818 to the decoded frame from the second stream to produce a first combined frame. The first combined frame can then be upscaled 820 to a larger resolution. Thereafter, the upscaled first combined frame can be added 822 to the decoded frame from the third stream to produce a second combined frame. In one implementation, the decoded frames being added 818 and 822 can sum pixel values on a pixel by pixel basis. The second combined frame can then be presented 824. For example, the presenting 824 of the second combined frame can cause the second combined frame to be displayed on a display on the media presentation device.

Following the presentation 824 of the resulting frame, a decision 826 can determine whether more frames of the multi-part media item file (i.e., more frames within the first, second and third streams) are to be similarly processed. When the decision 826 determines that there are more frames to be similarly processed, the media item presentation process 800 returns to repeat the block 806 so that a next frame from each of the first, second and third streams can be retrieved, decoded and then combined. However, when the decision 826 determines that there are no more additional frames to be processed, the media item presentation process 800 can end.

The media presentation device utilized herein can, for example, correspond to a computing device (e.g., personal computer), mobile phone (e.g., cellular phone), personal digital assistant (PDA), media player (e.g., music, videos, games, images), media storage device, camera, remote control, and/or the like. The media presentation device may also be a multi-functional device that combines two or more of these device functionalities into a single device. A few examples of multi-functional devices can be found in U.S. Patent Application Publication No. 20060197753, entitled “MULTI-FUNCTIONAL HAND-HELD DEVICE”, which is herein incorporated by reference.

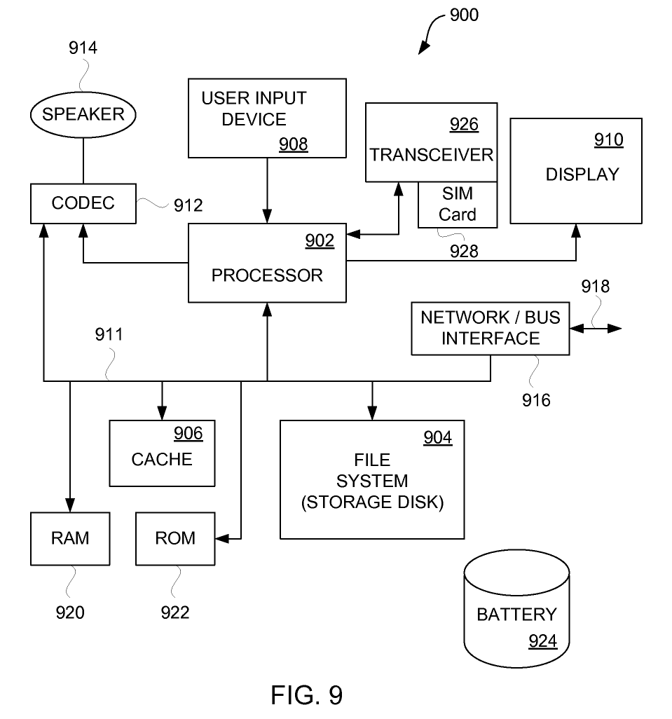

FIG. 9 is a block diagram of a mobile multi-function device 900 according to one embodiment of the invention. The mobile multi-function device 900 can represent one embodiment of a media presentation device. The mobile multi-function device 900 includes hardware and software components to provide at least two functions, namely, a media playback function and a wireless voice communications function. When providing media playback, the mobile multi-function device 900 can operate as a media player capable of playing (including displaying) media items. The media items can, for example, pertain to audio items (e.g., audio files or songs), videos (e.g., movies) or images (e.g., photos). When providing wireless voice communications, the mobile multi-function device 900 can operate a mobile telephone (e.g., cellular phone).

The mobile multi-function device 900 includes a processor 902 that pertains to a microprocessor or controller for controlling the overall operation of the mobile multi-function device 900. The mobile multi-function device 900 stores media data pertaining to media items in a file system 904 and a cache 906. In one embodiment, the file system 904 is implemented by a storage disk or a plurality of disks. In another embodiment, the file system 904 is implemented by EEPROM or Flash type memory. The file system 904 typically provides high capacity storage capability for the mobile multi-function device 900. However, since the access time to the file system 904 is relatively slow, the mobile multi-function device 900 can also include a cache 906. The cache 906 is, for example, Random-Access Memory (RAM) provided by semiconductor memory. The relative access time to the cache 906 is substantially shorter than for the file system 904. However, the cache 906 does not have the large storage capacity of the file system 904. Further, the file system 904, when active, consumes more power than does the cache 906. The power consumption is often a concern when the mobile multi-function device 900 is a portable mobile multi-function device that is powered by a battery 924. The mobile multi-function device 900 also includes a RAM 920 and a Read-Only Memory (ROM) 922. The ROM 922 can store programs, utilities or processes to be executed in a non-volatile manner. The ROM 922 can be implemented by an EEPROM or Flash type memory so as to provide writable non-volatile data storage. The RAM 920 provides volatile data storage, such as for the cache 906.

In one embodiment, to support wireless voice communications, the mobile multi-function device 900 includes a transceiver 926 and a SIM card 928. The transceiver 926 supports wireless communication with a wireless network (such as a wireless cellular network). The SIM card 928 includes an identifier (e.g., SIM identifier) can be used by the mobile multi-function device 900 to gain access and utilize the wireless network. In other embodiments, a SIM card 928 is not utilized.

The mobile multi-function device 900 also includes a user input device 908 that allows a user of the mobile multi-function device 900 to interact with the mobile multi-function device 900. For example, the user input device 908 can take a variety of forms, such as a button, keypad, dial, etc. Still further, the mobile multi-function device 900 includes a display 910 (screen display) that can be controlled by the processor 902 to display information to the user. The user input device 908 can also be implemented as a touch-sensitive device apart or integral with the display 910. A data bus 911 can facilitate data transfer between at least the file system 904, the cache 906, the processor 902, and the CODEC 912.

In one embodiment, the mobile multi-function device 900 serves to store a plurality of media items (e.g., songs) in the file system 904. When a user desires to have the mobile multi-function device play a particular media item, a list of available media items is displayed on the display 910. Then, using the user input device 908, a user can select one of the available media items. The processor 902, upon receiving a selection of a particular media item, can supply the media data (e.g., audio file) for the particular media item to a coder/decoder (CODEC) 912. The CODEC 912 can then produces analog output signals for a speaker 914. The speaker 914 can be a speaker internal to the mobile multi-function device 900 or external to the mobile multi-function device 900. For example, a headphone or earphone that connects to the mobile multi-function device 900 would be considered an external speaker.

The mobile multi-function device 900 can also includes a bus interface 916 that couples to a data link 918. The data link 918 can allow the mobile multi-function device 900 to couple to a host device (e.g., host computer or power source). The data link 918 can also provide power to the mobile multi-function device 900.

In one embodiment, the media presentation device can be a portable electronic device. The portable electronic device utilized herein can further be a hand-held electronic device. The term hand-held generally means that the electronic device has a form factor that is small enough to be comfortably held in one hand. A hand-held electronic device may be directed at one-handed operation or two-handed operation. In one-handed operation, a single hand is used to both support the device as well as to perform operations with the user interface during use. In two-handed operation, one hand is used to support the device while the other hand performs operations with a user interface during use or alternatively both hands support the device as well as perform operations during use. In some cases, the hand-held electronic device is sized for placement into a pocket of the user. By being pocket-sized, the user does not have to directly carry the device and therefore the device can be taken almost anywhere the user travels (e.g., the user is not limited by carrying a large, bulky and often heavy device).

The digital media assets (i.e., digital media items) can pertain to video items (e.g., video files or movies), audio items (e.g., audio files or audio tracks, such as for songs (music), podcasts or audiobooks), or image items (e.g., photos, slide shows).

Although the embodiments discussed above focus use of multi-part files to allow a single media item file to be used to provide different quality level files to different media presentation devices. In another embodiment, a video asset having widescreen support can be provided in a multi-part format, where the base part is the non-wide screen video (pan & scan window) and additional left and right parts can supplement the base part. Hence, for full widescreen, all three parts would be combined (i.e., stitched together). However, a presentation device not supporting widescreen playback would only need to decode and/or stream (or receive a streaming transmission) of the base part.

The various aspects, features, embodiments or implementations of the invention described above can be used alone or in various combinations.

The invention is preferably implemented by software, hardware, or a combination of hardware and software. The invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The advantages of the invention are numerous. Different aspects, embodiments or implementations may, but need not, yield one or more of the following advantages. One advantage of the invention is that digital media assets can be delivered in a single electronic file that can support various media presentation devices having different capabilities. Another advantage of the invention is that a host device can customize (e.g., optimize) the single electronic file for various media presentation devices without having to locally decode and re-encode media data within the single electronic file. Still another advantage of the invention is that a particular media presentation device is able to receive (e.g., from a host device) an electronic file that is suitable presentation at or near maximum resolution by the particular media presentation device. Yet still another advantage of the invention is that only a single electronic file needs to be downloaded such that multiple files or redundant information need not be downloaded.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for processing a digital media asset for presentation, said method comprising:
identifying a digital media asset having high quality video;
processing the high quality video to produce multiple reduced quality streams that are complementary;
distributing the multiple reduced quality video streams to a host device;
determining, at the host device, which of the multiple reduced quality video streams are to be downloaded to a particular media playback device;
downloading the determined video streams to the media playback device; and
presenting video for the digital media asset at the particular media playback device using the determined video streams that have been downloaded to the particular media playback device.

2. A method as recited in claim 1, wherein each of the reduced quality streams are smaller than a single high quality stream that could be produced from the high quality video.

3. A method as recited in claim 1, wherein said determining of the determined video streams to be downloaded to the particular media playback device comprises:
determining capabilities of the particular media playback device; and
determining the determined video streams based on the capabilities of the particular media playback device.

4. A method as recited in claim 1, wherein the capabilities of the media playback device comprise video playback capabilities.

5. A method as recited in claim 1, wherein the determined video streams to be downloaded to the particular media playback are dependent on video playback capabilities of the particular media playback device.

6. A method as recited in claim 1, wherein the multiple reduced quality video streams are provided within single electronic file.

7. A method as recited in claim 6, wherein the single electronic file is a multi-part media item file, with at least a plurality of its parts individually corresponding to a different one of the multiple reduced quality video streams.

8. A method of distributing media item data to a media playback device, said method comprising:
determining capabilities of the media playback device;
determining a set of parts of a media item having a multi-part format based on the capabilities of the media playback device; and
electronically delivering the determined set of parts of the media item to the media playback device.

9. A method as recited in claim 8, wherein the determined set of parts of the media item are a subset of the multiple parts of the media item.

10. A method as recited in claim 8, wherein the determined set of parts of the media item include only those of the multiple parts of the media item that can be presented at the media playback device.

11. A method as recited in claim 8, wherein the capabilities of the media playback device comprise video playback capabilities.

12. A method as recited in claim 8, wherein the determined set of parts of the media item are video streams, and
wherein said determining of the set of parts of the media item comprises determining two or more of the video streams based on the video playback capabilities of the media playback device.

13. A method as recited in claim 8, wherein the video streams within the multiple parts of the media item are complementary.

14. A method for presenting a media item on a media presentation device, said method:
identifying a multi-part media item file for the media item to be presented on the media presentation device;
retrieving a frame from a first stream provided in a first part of the multi-part media item file;
decoding the retrieved frame from the first stream;
retrieving a frame from a second stream provided in a second part of the multi-part media item file;
decoding the retrieved frame from the second stream; and
combining the decoded frame from the first stream with the decoded frame from the second stream to produce a resulting frame.

15. A method as recited in claim 14, wherein said method further comprises:
presenting the resulting frame.

16. A method as recited in claim 15, wherein said method further comprises:
determining whether there are more frames of the media item to be presented; and
processing another frame if said determining determines that there are one or more frames of the media item to be presented,
wherein said processing comprises:
retrieving another frame from the first stream;
decoding the retrieved another frame from the first stream;
retrieving another frame from a second stream;
decoding the retrieved another frame from the second stream;
adding the decoded another frame from the first stream to the decoded another frame from the second stream to produce a resulting another frame; and
presenting the resulting another frame.

17. A method as recited in claim 15, wherein the media presentation device is a media playback device, the media playback device having a display, and
wherein said presenting of the resulting frame comprises displaying the resulting frame on the display of the media playback device.

18. A method as recited in claim 14, wherein said method further comprises:
retrieving a frame from a third stream provided in a third part of the multi-part media item file; and
decoding the retrieved frame from the third stream.

19. A method as recited in claim 18, wherein
upscaling the resulting frame;
adding the upscaled resulting frame to the decoded frame from the third stream to produce a combined frame; and
presenting the combined frame.

20. A method as recited in claim 19, wherein the media presentation device is a media playback device, the media playback device having a display, and wherein said presenting of the combined frame comprises displaying the combined frame on the display of the media playback device.

21. A method as recited in claim 19, wherein said method further comprises:
determining whether there are more frames of the media item to be presented; and
processing another frame if said determining determines that there are one or more frames of the media item to be presented.

22. A computer readable medium including at least executable computer program code tangibly stored thereon for distributing media item data to a media playback device, said computer readable medium comprising:
computer program code for determining capabilities of the media playback device;
computer program code for determining a set of parts of a media item having a multi-part format based on the capabilities of the media playback device; and
computer program code for delivering the determined set of parts of the media item to the media playback device.

23. A computer readable medium including at least executable computer program code tangibly stored thereon for presenting a media item on a media presentation device, said computer readable medium comprising:
computer program code for identifying a multi-part media item file for the media item to be presented on the media presentation device;
computer program code for retrieving a frame from a first stream provided in a first part of the multi-part media item file;
computer program code for decoding the retrieved frame from the first stream;
computer program code for retrieving a frame from a second stream provided in a second part of the multi-part media item file;
computer program code for decoding the retrieved frame from the second stream; and
computer program code for combining the decoded frame from the first stream with the decoded frame from the second stream to produce a resulting frame.

24. A media asset distribution and presentation system, comprising:
an online media repository configured to store a plurality of digital media assets, each of the plurality of the digital media assets including multiple reduced quality streams that are complementary;
at least one media playback device having video playback capabilities; and
a host computer configured to operatively connect to said online media repository and said media playback device, said host computer further configured to (i) determine which of the multiple reduced quality video streams for a particular digital media asset are to be downloaded to said media playback device, and (ii) download the determined video streams to said media playback device,
wherein said media playback device can thereafter present video for the particular digital media asset by combining the determined video streams that have been downloaded to said media playback device.

25. A media asset distribution and presentation system as recited in claim 24,
wherein each of the plurality of the digital media assets is contained in a multi-part electronic file, and
wherein the multi-part electronic file for the particular digital media asset is downloaded from said online media repository to said host computer.
